(19) United States
(12) Patent Application Publication
(10) Pub. No.: US 2024/0145701 A1
(43) Pub. Date: May 2, 2024

(54) ORGANIC COATING LAYER, ELECTRODE ACTIVE MATERIAL INCLUDING THE SAME, ELECTRODE, AND BATTERY

(71) Applicant: ZHUHAI COSMX BATTERY CO., LTD., Zhuhai (CN)

(72) Inventors: Derui DONG, Zhuhai (CN); Zhaoshuai ZHANG, Zhuhai (CN); Wei ZHAO, Zhuhai (CN); Suli LI, Zhuhai (CN)

(73) Assignee: ZHUHAI COSMX BATTERY CO., LTD., Zhuhai (CN)

(21) Appl. No.: 18/398,713

(22) Filed: Dec. 28, 2023

Related U.S. Application Data
(63) Continuation-in-part of application No. PCT/CN2022/121281, filed on Sep. 26, 2022.

(30) Foreign Application Priority Data
Sep. 26, 2021 (CN) 202111130948.5

(51) Int. Cl. H01M 4/525; H01M 4/36; H01M 4/505; H01M 4/60; H01M 4/62; H01M 10/052

(52) U.S. Cl. CPC H01M 4/525; H01M 4/366; H01M 4/505; H01M 4/602; H01M 4/62; H01M 10/052; H01M 2004/027

(57) ABSTRACT

Disclosed are an organic coating layer, an electrode active material including the organic coating layer, and an electrode and a battery that include the electrode active material. The organic coating layer includes a lithiated polymer, and the polymer is a copolymer of a diisocyanate and an alcohol compound. The organic coating layer in the present disclosure can effectively suppress occurrence of an interface side reaction and electrode expansion, to improve cycling performance of the battery. The electrode active material includes an active material and the organic coating layer coated on a surface of the active material. The electrode active material in the present disclosure has an excellent ionic conductivity and lithium-ion conducting capability.

### CROSS-REFERENCE TO RELATED APPLICATIONS

The present disclosure is a continuation-in-part application of International Application No. PCT/CN2022/121281, filed on Sep. 26, 2022, which claims priority to Chinese Patent Application No.202111130948.5, filed on Sep. 26, 2021. All of the aforementioned patent applications are hereby incorporated by reference in their entireties.

### TECHNICAL FIELD

The present disclosure pertains to the technical field of electrochemical energy storage batteries, and specifically, to an organic coating layer, an electrode active material that includes the organic coating layer, and an electrode and a battery that include the electrode active material.

### BACKGROUND

Lithium batteries are one of batteries that are developing most quickly. However, as market demand for the lithium batteries increases, safety of the lithium batteries becomes increasingly prominent. Many spontaneous combustion accidents of mobile phones and automobiles are caused by decomposition of an internal electrolyte solution caused by a large quantity of heat generated due to a short circuit in a battery. In addition, with an increasing requirement on energy density of a lithium-ion battery, an enormous challenge is also made to an existing lithium-ion battery system.

In terms of a positive electrode, to improve cycling performance and C-rate performance of a positive electrode active material, a commonly used modification method is to perform surface coating on the positive electrode active material. In this case, direct contact between a electrolyte solution and a positive electrode active material may be avoided, and occurrence of a side reaction is reduced, thereby improving the cycling performance and the C-rate performance. In terms of a negative electrode, both a commercial graphite negative electrode material and a silicon-based negative electrode material with a broad prospect in the future had a problem that volume expansion easily occurs during cycling, especially when the silicon-based negative electrode material is used. In addition, the silicon-based negative electrode material still has poor conductivity. The foregoing problems may be resolved by coating the negative electrode active material. Therefore, coating an electrode material is a necessary and effective means. However, currently, there is a relatively single commercial coating means. Commonly used inorganic coating has a relatively poor lithium-conducting capability, and cannot meet a requirement of a next-generation lithium-ion battery.

Therefore, it is urgently necessary to develop a coating layer that has an excellent lithium-conducting capability and is more durable, to improve safety, a service life, and cycling performance of a solid-state battery.

### SUMMARY

To resolve the foregoing technical problems, the present disclosure provides an organic coating layer. The organic coating layer has both high mechanical strength and strong viscoelasticity, and has an excellent lithium-conducting capability and self-repairing function, so that occurrence of an interface side reaction and electrode expansion can be well suppressed. A crosslinking site that may crosslink amorphous polymer blocks exists in the organic coating layer, and further includes dynamic force such as a hydrogen bond and a coordination bond, so that tearing resistance of a polymer material may be significantly improved, and strength, ductility, and toughness of an elastomer material may also be significantly improved. In addition, a polymer in the organic coating layer may further cooperate with a lithium salt, so that an electrode in the present disclosure has an excellent ionic conductivity, thereby improving a lithium-ion conducting capability at an interface.

Another objective of the present disclosure is to provide a method for preparing an organic coating layer. The coating layer prepared in the method may be rapidly self-repaired both at a room temperature and in a heating condition. Battery performance is improved significantly. The preparation method is simple, and is suitable for industrial application.

Still another objective of the present disclosure is to provide an electrode active material. The electrode active material includes the foregoing organic coating layer. The electrode active material in the present disclosure has an excellent ionic conductivity and lithium-ion conducting capability.

Yet another objective of the present disclosure is to provide a battery that includes a positive electrode active material and/or a negative electrode active material that has/have the foregoing organic coating layer. In a battery cycling process, positive electrodes and/or negative electrodes that has/have the organic coating layer may heal rapidly even after a minor defect occurs, so that not only an interface side reaction between a solid-state electrolyte and an electrode can be resolved, but also an electrode deformation problem caused by electrode expansion in the battery cycling process may be suppressed, to improve battery cycling performance.

To implement the foregoing objectives, the following technical solutions are used in the present disclosure.

The present disclosure provides an organic coating layer. The organic coating layer includes a lithiated polymer, and the polymer is a copolymer of a diisocyanate and an alcohol compound.

According to the present disclosure, the lithiated polymer is a polymer obtained by further performing lithiation on the polymer of the diisocyanate and the alcohol compound.

According to the present disclosure, a structural formula of the diisocyanate is shown in formula 1:

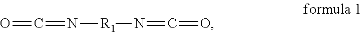

where R₁ is a hydrocarbyl of C6-C18.

The diisocyanate is selected from at least one of toluene diisocyanate (TDI), isophorone diisocyanate (IPDI), methylene diphenyl diisocyanate (MDI), 4,4′-methylenebis(cyclohexyl isocyanate), (HMDI), hexamethylene diisocyanate (HDI), lysine diisocyanate (LDI), or diphenyl methane diisocyanate (MPI).

According to the present disclosure, the alcohol compound is selected from at least one of diols.

In the present disclosure, the term “diol” has a conventional meaning in the art, and the term “diol” refers to an alcohol including two hydrocarbyls in a molecule.

According to the present disclosure, the alcohol compound is pentaethylene glycol.

According to the present disclosure, during the lithiation, a lithium reagent is used, and the lithium reagent is selected from at least one of lithium hydride, butyl lithium, ethyl lithium, phenyl lithium, or methyl lithium.

According to the present disclosure, in the lithiated polymer, a molar ratio of the diisocyanate, the alcohol compound based on —OH (a hydrocarbyl), and the lithium reagent based on Li⁺ is 1:(1.5-2.5):(1.5-2.5), for example, is 1:1.5:1.5, 1:2:2, or 1:2.5:2.5.

Preferably, in the lithiated polymer, a molar ratio of the diisocyanate, the alcohol compound based on —OH (a hydrocarbyl), and the lithium reagent based on Li⁺ is 1:(2.01-2.05):(2.01-2.05).

In the present disclosure, the term “B based on A” refers to a quantity of As in B as a quantized object. For example, “the alcohol compound based on —OH (a hydrocarbyl)” means that when a molar ratio is calculated, a molar mass of the alcoholic compound is replaced with a molar mass of —OH (a hydrocarbyl). For example, when 1 mol of pentylethylene glycol is used, “pentaethylene glycol based on —OH (a hydrocarbyl)” is 2 mol.

According to the present disclosure, the lithiated polymer has a structure shown in formula 2:

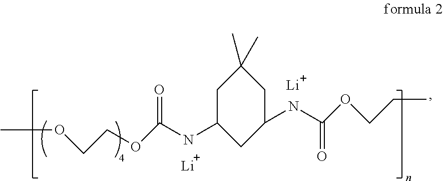

where in the formula 2, n is a degree of polymerization.

In the present disclosure, the term “degree of polymerization” has a conventional meaning in the art and is generally considered to be an indicator for measuring a size of a polymer molecule. A quantity of repeating units is used as a reference, that is, an average value of quantities of repeating units included in a macromolecular chain of the polymer.

According to the present disclosure, n ranges from 2 to 1.9×10⁶, and for example, is 2, 10, 100, 1×10³, 1×10⁴, 1×10⁵, 1×10⁶, or 1.9×10⁹.

According to the present disclosure, the organic coating layer further includes an ion conductor.

According to the present disclosure, using a total weight of the organic coating layer as a reference, a content of the ion conductor ranges from 3 wt % to 8 wt %, for example, is 3 wt %, 4 wt %, 5 wt %, 6 wt %, 7 wt %, or 8 wt %.

According to the present disclosure, the ion conductor includes at least a lithium salt.

Preferably, the ion conductor is selected from a combination of a lithium salt and at least one of the following materials: an inorganic filler, a magnesium salt, or a sodium salt.

According to the present disclosure, the lithium salt is selected from at least one of lithium bis(oxalate)borate, lithium difluoro(oxalato)borate, lithium hexafluoroarsenate, lithium tetrafluoroborate, lithium trifluoromethanesulfonate, lithium nitrate, lithium bis(fluorosulfonyl)imide, lithium perchlorate, lithium hexafluorophosphate, lithium bistrifluoromethylsulfonimide (LiTFSI), or lithium difluorophosphate.

According to the present disclosure, the inorganic filler is selected from at least one of Li₇La₃Zr₂O₁₂, Al₂O₃, TiO₂, Li_{6.28}La₃Zr₂Al_{0.24}O₁₂, Li_{6.75}La₃Nb_{0.25}Zr_{1.75}O₁₂, Li_{6.75}La₃Zr_{1.75}Ta_{0.25}O₁₂ (LLZTO), BaTiO₃, ZrO₂, SiO₂, L_{1.5}Al_{0.5}Ge_{1.5}(PO₄)₃, or montmorillonite.

According to the present disclosure, the magnesium salt is selected from at least one of magnesium bis(trifluoromethanesulfonimide) (Mg(TFSI)₂) or MgClO₄.

According to the present disclosure, the sodium salt is selected from at least one of sodium difluoro(oxalato)borate (NaDFOB), sodium bis(trifluoromethanesulphonyl)imide (NaTFSI), or NaPF₆.

According to the present disclosure, a mass ratio of the lithium salt to at least one of the inorganic filler, the magnesium salt, or the sodium salt is 1:(0.1-1), such as 1:0.1, 1:0.2, 1:0.3, 1:0.4, 1:0.5, 1:0.6, 1:0.7, 1:0.8, 1:0.9, or 1:1.

The present disclosure further provides a composition for preparing the foregoing organic coating layer, where the composition includes the following components: a diisocyanate, an alcohol compound, and a lithium reagent.

According to the present disclosure, the diisocyanate, the alcohol compound, and the lithium reagent have the meanings and choices described above.

According to the present disclosure, using a total weight of the composition as a reference, a content of the diisocyanate ranges from 15 wt % to 35 wt %, for example, is 15 wt %, 20 wt %, 25 wt %, 30 wt %, or 35 wt %.

According to the present disclosure, using the total weight of the composition as a reference, a content of the alcohol compound ranges from 15 wt % to 35 wt %, for example, is 15 wt %, 20 wt %, 25 wt %, 30 wt %, or 35 wt %.

According to the present disclosure, using the total weight of the composition as a reference, a content of the lithium reagent ranges from 25 wt % to 60 wt %, for example, is 25 wt %, 30 wt %, 35 wt %, 40 wt %, 45 wt %, 50 wt %, 55 wt %, or 60 wt %.

According to the present disclosure, the composition further optionally includes an ion conductor.

According to the present disclosure, using a total weight of the composition as a reference, a content of the ion conductor ranges from 3 wt % to 8 wt %, for example, is 3 wt %, 4 wt %, 5 wt %, 6 wt %, 7 wt %, or 8 wt %.

Preferably, the ion conductor includes at least a lithium salt.

According to the present disclosure, the composition further optionally includes a catalyst.

For example, using the total weight of the composition as a reference, a content of the catalyst ranges from 0.001 wt % to 1 wt %, for example, is 0.001 wt %, 0.005 wt %, 0.01 wt %, 0.05 wt %, 0.1 wt %, 0.5 wt %, or 1 wt %.

For example, the catalyst is selected from at least one of dibutyltin dilaurate (DBTDL), stannous octanoate, or zinc oxalate.

According to the present disclosure, the organic coating layer is a polymerisate of the foregoing composition.

The present disclosure further provides a method for preparing the foregoing organic coating layer, including the following steps: under an action of a catalyst, polymerizing a composition including the following components to obtain the lithiated polymer: a diisocyanate, an alcohol compound, and a lithium reagent.

According to the present disclosure, definitions and contents of the components in the organic coating layer are as described above.

According to the present disclosure, the composition further optionally includes an ion conductor.

According to the present disclosure, polymerizing the composition is performed in a solvent.

For example, the solvent includes but is not limited to at least one of an organic solvent such as acetonitrile (ACN), dimethyl sulfoxide (DMSO), tetrahydrofuran (THF), dimethylformamide (DMF), dimethylacetamide (DMAC), ethanol, or acetone.

In an implementation of the present disclosure, the method for preparing the organic coating layer includes the following steps:
(1) polymerizing the diisocyanate and the alcohol compound to obtain a polymer; and
(2) reacting a reaction product of step (1) with the lithium reagent to obtain a lithiated polymer through preparation.

According to the present disclosure, in step (1), a temperature of polymerization ranges from 70° C. to 90° C., and may be, for example, is 70° C., 75° C., 80° C., 85° C., or 90° C. A time of the polymerization ranges from 24 hours to 48 hours, for example, is 24 hours, 36 hours, or 48 hours. The polymerization is performed in an inert atmosphere (such as nitrogen or argon).

According to the present disclosure, in step (2), a temperature of reaction (lithiation) ranges from 70° C. to 90° C., for example, is 70° C., 75° C., 80° C., 85° C., or 90° C. A time of the reaction (lithiation) is, for example, more than 24 hours, preferably, is 24 hours to 48 hours, for example, is 24 hours, 36 hours, or 48 hours.

According to the present disclosure, the preparation method further includes step (3): further adding the ion conductor to obtain the organic coating layer through preparation.

According to the present disclosure, step (3) may further include performing heating and curing the ion conductor in a vacuum condition after the ion conductor is added. For example, a heating and curing temperature ranges from 60° C. to 100° C., and a heating and curing time ranges from 12 hours to 96 hours. For another example, the heating and curing temperature ranges from 80° C. to 90° C., and the heating and curing time ranges from 24 hours to 48 hours.

The present disclosure further provides an electrode active material, where the electrode active material includes an active material and the foregoing organic coating layer coated on a surface of the active material.

According to the present disclosure, a thickness of the organic coating layer may ranges from 1 nm to 100 nm, preferably is 1 nm to 50 nm, for example, is 1 nm, 5 nm, 8 nm, 10 nm, 20 nm, 30 nm, 50 nm, 100 nm, or any point value in a range formed by the foregoing two values.

According to the present disclosure, the active material may be a positive electrode active material or a negative electrode active material.

According to the present disclosure, in the electrode active material, a mass ratio of the positive electrode active material or the negative electrode active material to the organic coating layer is 100:(0.1-5), for example, is 100:0.1, 100:0.2, 100:0.5, 100:1, 100:2, 100:3, 100:4, or 100:5.

Preferably, the positive electrode active material is selected from at least one of a lithium ferrous phosphate (LiFePO₄), lithium cobalt oxide (LiCoO₂), lithium nickel cobalt manganese (Li_{z}NiₓCo_{y}Mn_{1-x-y}O₂, where 0.95≤z≤1.05, x>0, y>0, and x+y<1), lithium manganese (LiMnO₂), lithium nickel cobalt aluminum (Li_{z}NiₓCo_{y}Al_{1-x-y}O₂, where 0.95≤z≤1.05, x>0, y>0, and 0.8≤x+y<1), lithium nickel cobalt manganese aluminum (Li_{z}NiₓCO_{y}Mn_{w}Al_{1-x-y-w}O₂, where 0.95≤z≤1.05, x>0, y>0, w>0, and 0.8≤x+y+w<1), nickel-cobalt-aluminum-tungsten material, lithium-rich manganese-based solid solution positive electrode material, lithium nickel cobalt oxide (LiNiₓCo_{y}O₂, where x>0, y>0, and x+y=1), lithium nickel titanium manganese oxide (LiNiₓTi_{y}Mg_{z}O₂, where x>0, y>0, z>0, and x+y+z=1), lithium nickel oxide (Li₂NiO₂), spinel lithium manganate (LiMn₂O₄), or nickel-cobalt-tungsten material.

Preferably, the negative electrode active material is selected from at least one of a carbon material, metal bismuth, metal lithium, metal copper, metal indium, a nitride, a lithium-based alloy, a magnesium-based alloy, an indium-based alloy, a boron-based material, a silicon-based material, a tin-based material, an antimony-based alloy, a gallium-based alloy, a germanium-based alloy, an aluminum-based alloy, a lead-based alloy, a zinc-based alloy, an oxide of titanium, an oxide of iron, an oxide of chromium, an oxide of molybdenum, or a phosphide.

More preferably, the negative electrode active material includes but is not limited to at least one of the metal lithium, a lithium-based alloy LiₓM (M=In, B, Al, Ga, Sn, Si, Ge, Pb, As, Bi, Sb, Cu, Ag, or Zn), the carbon material (for example, is graphite, amorphous carbon, or mesocarbon microbead), the silicon-based material (for example, is a silicon-carbon material or a nano-silicon), the tin-based material, and the lithium titanate (for example, is Li₄Ti₅O₁₂).

The present disclosure further provides a method for preparing the foregoing electrode active material, including: under an action of a catalyst, polymerizing a composition including the following components to obtain the electrode active materials: a diisocyanate, an alcohol compound, a lithium reagent, and an active material.

According to the present disclosure, definitions and contents of the components in the composition are as described above.

According to the present disclosure, the composition further optionally includes an ion conductor.

According to the present disclosure, polymerizing the composition is performed in a solvent.

For example, the solvent includes but is not limited to at least one of an organic solvent such as ACN, DMSO, THF, DMF, DMAC, ethanol, or acetone.

According to the present disclosure, the method for preparing the electrode active material includes: for example, first dissolving the diisocyanate in the solvent, adding the alcohol compound and the catalyst, and performing heating and stirring in an inert atmosphere; and then, mixing a product with the lithium reagent and the active material, and performing heating and curing, to obtain the electrode active material through preparation.

In an implementation of the present disclosure, the method for preparing the electrode active material includes the following steps:

S1: polymerizing the diisocyanate and the alcohol compound to obtain a polymer;

S2: reacting the polymer obtained in step S1 through preparation with the lithium reagent, to obtain a lithiated polymer after lithiation; and

S3: adding the ion conductor and the active material, and perform heating and curing in a vacuum condition, to obtain the electrode active material through preparation.

According to the present disclosure, in step S1, a temperature of polymerization ranges from 70° C. to 90° C., and may be, for example, is 70° C., 75° C., 80° C., 85° C., or 90° C. A time of the polymerization ranges from 24 hours to 48 hours, for example, is 24 hours, 36 hours, or 48 hours. The polymerization is performed in an inert atmosphere (such as nitrogen or argon).

According to the present disclosure, the method for preparing the electrode active material further includes removing an impurity from the polymer obtained in step S1 through preparation, to remove an excess isocyanate group. For example, an alcohol solvent is added to the polymer obtained in step S1 through preparation, and stirring is performed (for example, for 1 hour to 5 hours), to remove an excess isocyanate group to obtain a polymer solution. For example, the alcohol solvent may be methanol or ethanol.

According to the present disclosure, in step S2, a temperature of reaction (lithiation) ranges from 70° C. to 90° C., for example, is 70° C., 75° C., 80° C., 85° C., or 90° C. A time of the reaction (lithiation) is, for example, more than 24 hours, preferably, is 24 hours to 48 hours, for example, is 24 hours, 36 hours, or 48 hours.

According to the present disclosure, in step S3, for example, a heating and curing temperature ranges from 60° C. to 100° C., and a heating and curing time ranges from 12 hours to 96 hours. For another example, the heating and curing temperature ranges from 80° C. to 90° C., and the heating and curing time ranges from 24 hours to 48 hours.

The present disclosure further provides an electrode. The electrode includes the foregoing electrode active material.

According to the present disclosure, the electrode may be a positive electrode or a negative electrode. Preferably, the electrode is a positive electrode.

According to the present disclosure, the electrode further optionally includes a conductive agent and/or a binder.

Preferably, in the electrode, a mass ratio of the electrode active material to the binder and the conductive agent is (60-99):(0.1-20):(0.1-20). In the mass ratio, a sum of a mass part of the electrode active material, a mass part of the binder, and a mass part of the conductive agent is 100, for example, is 60:20:20, 70:20:10, 80:10:10, 90:5:5, 92:3:5, 94:2:4, 95:3:2, 99:0.5:0.5, 99:0.1:0.9, or 99:0.9:0.1.

For example, the binder may be one, two, or more of polyvinylidene fluoride (PVDF), sodium carboxymethyl cellulose (CMC-Na), and styrene-butadiene rubber (SBR), and preferably, is the polyvinylidene fluoride.

For example, the conductive agent may be at least one of conductive carbon black (Super-P) or conductive graphite (KS-6).

The present disclosure further provides an application of the foregoing electrode active material and/or electrode in a battery.

According to the present disclosure, the battery is a secondary battery, a solid-state battery, or a gel battery.

For example, the secondary battery may be various types of ion secondary batteries, such as a lithium, sodium, magnesium, aluminum, or zinc ion secondary battery.

For example, the solid-state battery may be a full-solid-state battery, a quasi-solid-state battery, or a semi-solid-state battery. For example, the solid-state battery is at least one of a button battery, an aluminum shell battery, a pouch battery, or a solid-state lithium-ion battery.

The present disclosure further provides a battery, where the battery includes the foregoing electrode active material and/or electrode.

According to the present disclosure, the battery further includes an electrolyte and/or an electrolyte solution.

According to an implementation of the present disclosure, the battery includes a positive electrode and a negative electrode of the foregoing organic coating layer, and there is an electrolyte between the positive electrode and the negative electrode.

According to an implementation of the present disclosure, the battery includes a positive electrode of the foregoing organic coating layer, a separator, and a negative electrode, and there is an electrolyte solution among the positive electrode, the separator, and the negative electrode.

According to an implementation of the present disclosure, the battery includes a positive electrode, and a negative electrode of the foregoing organic coating layer, and there is an electrolyte between the positive electrode and the negative electrode.

According to an implementation of the present disclosure, the battery includes a positive electrode, a separator, and a negative electrode of the foregoing organic coating layer, and there is an electrolyte solution among the positive electrode, the separator, and the negative electrode.

According to an implementation of the present disclosure, the battery includes the positive electrode of the foregoing organic coating layer and the negative electrode of the foregoing organic coating layer, and there is an electrolyte between the positive electrode and the negative electrode.

According to an implementation of the present disclosure, the battery includes the positive electrode of the foregoing organic coating layer, a separator, and the negative electrode of the foregoing organic coating layer, and there is an electrolyte solution among the positive electrode, the separator, and the negative electrode.

The present disclosure further provides a method for preparing the foregoing battery. For example, the method includes sequentially stacking a positive electrode, an electrolyte, and a negative electrode together, and performing vacuum packaging, to obtain the battery.

For another example, the method includes sequentially stacking a positive electrode, a separator, and a negative electrode together, injecting an electrolyte solution, and performing vacuum packaging, to obtain the battery.

Beneficial effects of the present disclosure are as follows.

Firstly, the organic coating layer in the present disclosure serves as a lithium-ion conductor, and is conducive to Li⁺ transmission in a charging/discharging process. A coating effect of the organic coating layer can reduce direct contact between the active material and the electrolyte solution without affecting Li⁺ diffusion, thereby reducing occurrence of a side reaction. In addition, coating on the surface of the electrode active material may effectively alleviate destruction, collapse, or aggregation caused by corrosion of the electrode active material, to improve structural stability of the electrode active material.

Secondly, the organic coating layer in the present disclosure has an excellent chain-segment motion capability, and has rigidity and elasticity, so that no breakage can occur when large stress occurs in a cycling process, thereby effectively suppressing an electrode expansion problem of a negative electrode material in the cycling process, to further improve safety performance of the battery.

Lastly, the organic coating layer in the present disclosure may be applicable to various types of ion secondary batteries, such as a lithium, sodium, magnesium, aluminum, or zinc ion secondary batteries, an all-solid-state battery, a quasi-solid-state battery, or a gel battery by adjusting a type and/or a ratio of components, and has good interface performance and excellent cycling performance.

### BRIEF DESCRIPTION OF THE DRAWINGS

FIG. 1 is a schematic structural diagram of an electrode coated by an organic coating layer.

FIG. 2 is a TEM image of a positive electrode material coated by an organic coating layer in Example 1.

FIG. 3 is a diagram of cycling performance of a lithium-ion battery with 1 C/1 C at 25° C. according to an example.

### DETAILED DESCRIPTION OF THE EMBODIMENTS

Technical solutions of the present disclosure are further described in detail below with reference to specific embodiments. It should be understood that the following embodiments are merely for the purposes of illustrating and explaining the present disclosure, and should not be construed as limiting the protection scope of the present disclosure. Any technology implemented based on the foregoing contents of the present disclosure falls within the intended protection scope of the present disclosure.

Unless otherwise stated, raw materials and reagents used in the following examples are commercially available commodities, or may be prepared by a known method.

Battery EIS test: In a 25° C. environment, a battery is in a 50% SOC state, and an amplitude of 5 Mv and a test frequency of 1 MHZ to 0.1 HZ are obtained by using an EIS alternating current impedance test method.

Test of a quantity of battery cycling times: After the battery is obtained through assembly, cycling performance is tested by using a LAND blue battery test system with a charge/discharge current of 1 C/1 C at 25° C.

### EXAMPLE 1

### Preparation of an Electrode Active Material Coated by an Organic Coating Layer

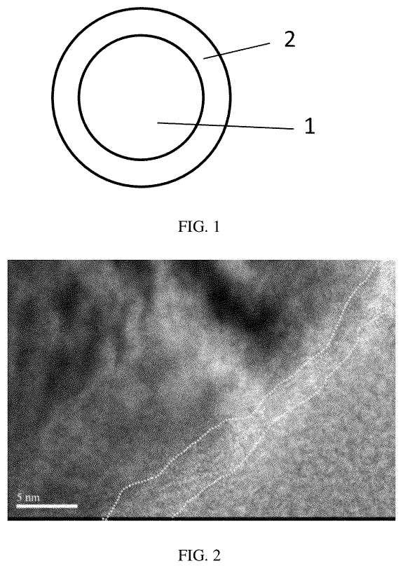

(1) Dissolving 1.5 g of isophorone diisocyanate (IPDI) in 100 ml of anhydrous DMF, and performing stirring and mixing in an argon atmosphere.
(2) Adding 1.6 g of pentaethylene glycol and 5 μL of dibutyltin dilaurate (DBTDL) to the foregoing solution, and performing stirring at 80° C. for 24 hours.
(3) Adding 3 ml of methanol to the foregoing solution, performing stirring for 1 hour, and removing an excess isocyanate group.
(4) Adding 3 g of lithium hydride to the foregoing solution, and performing stirring at 80° C. for 24 hours, to perform a lithium reaction.
(5) Adding 0.3 g of a lithium salt LiTFSI, 0.2 g of Li_{6.75}La₃Zr_{1.75}Ta_{0.25}O₁₂ (LLZTO) powder, and 500 g of positive electrode active material LiNi_{0.8}Co_{0.1}Mn_{0.1}O₂ powder to the foregoing solution, performing stirring evenly, and performing heating and curing in a vacuum condition, to obtain a positive electrode active material LiNi_{0.8}Co_{0.1}Mn_{0.1}O₂ coated by the organic coating layer, where a thickness of the organic coating layer ranges from 2 nm to 3 nm, and a specific structural diagram is shown in FIG. 1.

A positive electrode plate was prepared: Conductive carbon black as a conductive agent, PVDF as a binder, and N-methylpyrrolidone (NMP) as a solvent were stirred evenly, and then the positive electrode active material LiNi_{0.8}Co_{0.1}Mn_{0.1}O₂ coated by the foregoing organic coating layer was added. In the mixture, a solid component included 90 wt % positive electrode active material LiNi_{0.8}Co_{0.1}Mn_{0.1}O₂ coated by the organic coating layer, 5 wt % binder PVDF, and 5 wt % conductive carbon black. A current collector was 10 μm aluminium foil.

A negative electrode plate was prepared: Conductive carbon black as a conductive agent, SBR as a binder, and NMP as a solvent were stirred evenly, and then an artificial graphite negative electrode active material was added. In the mixture, a solid component included 95 wt % artificial graphite, 2 wt % binder SBR, and 3 wt % conductive carbon black. A current collector is 6 μm copper foil.

A lithium-ion battery was prepared: Artificial graphite as a negative electrode (a coating quantity is 8 mg/cm²) was used, and the foregoing positive electrode plate (a coating quantity is 14 mg/cm²) and a commercial electrolyte solution of an LiPF₆ system were wound and assembled into a pouch lithium-ion battery, which assisted in packaging with a common battery tab and an aluminum-plastic film.

Test condition: testing cycling performance with a charge/discharge current of 1 C/1 C, where a voltage test range is 2.8 V to 4.3 V, and a test result is shown in Table 1.

FIG. 2 is a TEM image of a positive electrode active material LiNi_{0.8}Co_{0.1}Mn_{0.1}O₂ coated by the organic coating layer obtained in Example 1 through preparation. In FIG. 2, two white dotted lines divide FIG. 2 into three parts, where an upper left side of the dotted line is a background, a part sandwiched between the two dotted lines is a coating layer, and a lower right side of the dotted line is a positive electrode material. It can be learned from the figure that an organic coating layer is successfully coated on a surface of an active material.

### EXAMPLE 2

### Preparation of an Electrode Active Material Coated by an Organic Coating Layer

(1) Dissolving 1.5 g of diphenylmethane diisocyanate (MPI) in 100 ml of anhydrous DMF, and performing stirring and mixing in an argon atmosphere.
(2) Adding 1.6 g of pentaethylene glycol and 5 μL of dibutyltin dilaurate (DBTDL) to the foregoing solution, and performing stirring at 80° C. for 24 hours.
(3) Adding 3 ml of methanol to the foregoing solution, performing stirring for 1 hour, and removing an excess isocyanate group.
(4) Adding 3 g of lithium hydride to the foregoing solution, and performing stirring at 80° C. for 24 hours, to perform a lithium reaction.
(5) Adding 0.3 g of a lithium salt LiTFSI, 0.2 g of LLZTO powder, and 500 g of a positive electrode active material LiCoO₂ powder to the foregoing solution, performing stirring evenly, and performing heating and curing in a vacuum condition, to obtain a positive electrode active material LiCoO₂ coated by the organic coating layer, where a thickness of the organic coating layer ranges from 2 nm to 3 nm.

A positive electrode plate was prepared: Conductive carbon black as a conductive agent, PVDF as a binder, and NMP as a solvent were stirred evenly, and then LiCoO₂ coated by the foregoing organic coating layer was added. In the mixture, a solid component included 94 wt % LiCoO₂ coated by the organic coating layer, 2 wt % binder PVDF, and 4 wt % conductive carbon black. A current collector was 10 μm aluminum foil.

A negative electrode plate was prepared: Conductive carbon black as a conductive agent, SBR as a binder, and NMP as a solvent were stirred evenly, and then a silicon monoxide negative electrode active material was added. In the mixture, a solid component included 95 wt % silicon monoxide, 2 wt % binder SBR, and 3 wt % conductive carbon black. A current collector was 6 μm copper foil.

A lithium-ion battery was prepared: Silicon monoxide material was used as a negative electrode (a coating quantity is 5 mg/cm²), and the foregoing positive electrode plate (a coating quantity is 23 mg/cm²) and a commercial electrolyte solution of an LiPF₆ system were wound and assembled into a pouch lithium-ion battery, which assisted in packaging with a common battery tab and a square aluminum shell.

Test condition: testing cycling performance with a charge/discharge current of 1 C/1 C, where a voltage test range is 2.5 V to 4.45 V, a test method is the same as that in Example 1, and a test result is shown in Table 1.

### EXAMPLE 3

### Preparation of an Electrode Active Material Coated by an Organic Coating Layer

(1) Dissolving 1.5 g of 4,4′-methylenebis(cyclohexyl isocyanate), (HMDI) in 100 ml of anhydrous DMF, and performing stirring and mixing in an argon atmosphere.
(2) Adding 1.6 g of pentaethylene glycol and 5 μL of dibutyltin dilaurate (DBTDL) to the foregoing solution, and performing stirring at 80° C. for 24 hours.
(3) Adding 3 ml of methanol to the foregoing solution, performing stirring for 1 hour, and removing an excess isocyanate group.
(4) Adding 3 g of lithium hydride to the foregoing solution, and performing stirring at 80° C. for 24 hours, to perform a lithium reaction.
(5) Adding 0.3 g of a lithium salt LiTFSI, 0.2 g of LLZTO powder, and 500 g of a positive electrode active material LiFePO₄ powder to the foregoing solution, performing stirring evenly, and performing heating and curing in a vacuum condition, to obtain a positive electrode active material LiFePO₄ coated by the organic coating layer, where a thickness of the organic coating layer ranges from 2 nm to 3 nm.

A positive electrode plate was prepared: Carbon black as a conductive agent and copolymer of vinylidene fluoride-hexafluoropropylene (PVDF-HFP) as a binder were stirred, and then a positive electrode active material LiFePO₄ coated by the foregoing organic coating layer was added. In the mixture, a solid component included 95 wt % positive electrode active material LiFePO₄ coated by the organic coating layer, a 2 wt % binder, 1.5 wt % carbon nanotubes, and 1.5 wt % Super-P. A current collector was 9 μm aluminum foil.

A solid-state electrolyte was prepared: Polycaprolactone, LiTFSI, and succinonitrile in THF as raw materials were dissolved at a ratio of 8:3:2, and a substrate is coated to form a film, where after drying, a thickness of a polymer solid-state electrolyte was 30 μm.

A lithium-ion battery was prepared: Metal lithium foil was used as a negative electrode (a thickness is 20 μm), and the foregoing positive electrode plate (a coating quantity is 13 mg/cm²) and the foregoing polymer solid-state electrolyte (30 μm) were assembled into an all-solid-state lithium battery, where the positive electrode, the solid-state electrolyte, and the negative electrode were successively stacked, to assist in packaging with a common battery tab and an aluminum-plastic film.

Test condition: testing cycling performance with a charge/discharge current of 1 C/1 C, where a voltage test range is 2.0 V to 3.65 V, and a test result is shown in Table 1.

### EXAMPLE 4

### Preparation of an Electrode Active Material Coated by an Organic Coating Layer

(1) Dissolving 1.5 g of hexamethylene diisocyanate (HDI) in 100 ml of anhydrous DMF, and performing stirring and mixing in an argon atmosphere.
(2) Adding 1.6 g of pentaethylene glycol and 5 μL of dibutyltin dilaurate (DBTDL) to the foregoing solution, and performing stirring at 80° C. for 24 hours.
(3) Adding 3 ml of methanol to the foregoing solution, performing stirring for 1 hour, and removing an excess isocyanate group.
(4) Adding 3 g of lithium hydride to the foregoing solution, and performing stirring at 80° C. for 24 hours, to perform a lithium reaction.
(5) Adding 0.3 g of a lithium salt LiTFSI, 0.2 g of LLZTO powder, and 500 g of silicon monoxide SiO x powder to the foregoing solution, performing stirring evenly, and perform heating and curing in a vacuum condition, to obtain a negative electrode active material silicon monoxide SiOₓ coated by the organic coating layer, where a thickness of the organic coating layer ranges from 2 nm to 3 nm.

A positive electrode plate was prepared: Carbon black as a conductive agent and PVDF as a binder were stirred evenly, and then a positive electrode active material lithium nickel cobalt aluminate was added. In the mixture, a solid component included 90 wt % LiNi_{0.6}Co_{0.2}Al_{0.2}O₂, 5 wt % binder PVDF, and 5 wt % conductive carbon black. A current collector was 10 μm aluminum foil.

A negative electrode plate was prepared: 80% graphite and 20% SiOₓ coated by the organic coating layer were mixed evenly as a negative electrode active material (92%), and carbon nanotubes and SP were used as a conductive agent (5%), and PVDF was used as a binder (3%), where a current collector was 8 μm copper foil.

A lithium-ion battery was prepared: Silicon carbon composite material (includes 20% SiOₓ coated by the organic coating layer and 80% graphite) was used as a negative electrode (a coating quantity is 6 mg/cm²), and the foregoing positive electrode plate (a coating quantity is 15 mg/cm²) and a commercial electrolyte solution LiPF₆ were assembled into a pouch lithium-ion battery through stacking, which assisted in packaging with a common battery tab and an aluminum-plastic film.

Test condition: testing cycling performance with a charge/discharge current of 1 C/1 C, where a voltage test range is 3.0 V to 4.2 V, and a test result is shown in Table 1.

### EXAMPLE 5

### Preparation of an Electrode Active Material Coated by an Organic Coating Layer

(1) Dissolving 1.5 g of toluene diisocyanate (TDI) in 100 ml of anhydrous DMF, and performing stirring and mixing in an argon atmosphere.
(2) Adding 1.6 g of pentaethylene glycol and 5 μL of dibutyltin dilaurate (DBTDL) to the foregoing solution, and performing stirring at 80° C. for 24 hours.
(3) Adding 3 ml of methanol to the foregoing solution, performing stirring for 1 hour, and removing an excess isocyanate group.
(4) Adding 3 g of lithium hydride to the foregoing solution, and performing stirring at 80° C. for 24 hours, to perform a lithium reaction.
(5) Adding 0.3 g of a lithium salt LiTFSI, 0.2 g of LLZTO powder, and 500 g of silicon monoxide SiOx powder to the foregoing solution, performing stirring evenly, and performing heating and curing in a vacuum condition, to obtain a negative electrode active material silicon monoxide SiOₓ coated by the organic coating layer, where a thickness of the organic coating layer ranges from 2 nm to 3 nm.

A positive electrode plate was prepared: Acetylene black as a conductive agent and PVDF-HFP as a binder were stirred evenly, and then positive electrode active material lithium nickel cobalt manganese was added. In the mixture, a solid component included 95 wt % LiNi_{0.5}Co_{0.3}Mn_{0.2}O₂, a 2 wt % binder, and 3 wt % acetylene black. A current collector was 9 μm Al foil.

A negative electrode plate was prepared: Silicon monoxide SiOₓ coated by the organic coating layer was used as a negative electrode active material (85%), single-walled carbon nanotubes (3%) and SP were used as a conductive agent (4%), and PVDF was used as a binder (8%).

A lithium-ion battery was prepared: Silicon monoxide SiOₓ coated by the organic coating layer was used as a negative electrode (6 mg/cm²), and the foregoing positive electrode plate (21 mg/cm²) and a commercial electrolyte solution LiPF₆ were assembled into a pouch lithium-ion battery through stacking, which assisted in packaging with a common battery tab and an aluminum-plastic film.

Test condition: testing cycling performance with a charge/discharge current of 1 C/1 C, where a voltage test range is 2.7 V to 4.35 V, and a test result is shown in Table 1.

In Comparative Examples 1 to 5, except that there is no organic polymer material coating layer, other preparation processes and materials used are the same as those in Example 1 to Example 5.

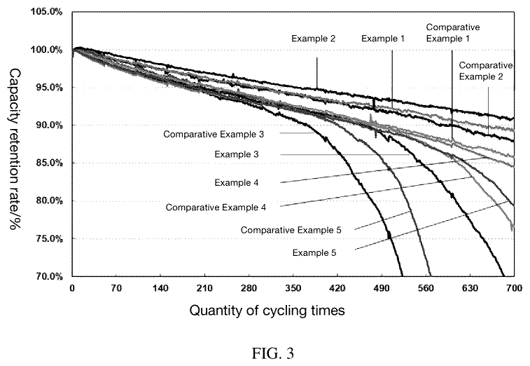

FIG. 3 is a diagram of cycling performance of a lithium-ion battery with 1 C/1 C at 25° C. in Example 1 to Example 5 and the Comparative Examples 1 to 5. It can be learned from FIG. 3 that, in Example 1 to Example 3, cycling performance of the battery obtained through preparation by using the positive electrode material coated by the organic coating layer is significantly better than that of a battery obtained through preparation by using an uncoated positive electrode material in the Comparative Examples 1 to 3. In Example 4 and Example 5, cycling performance of the battery obtained through preparation by using the negative electrode material coated by the organic coating layer is significantly better than that of a battery obtained through preparation by using an uncoated negative electrode material in the Comparative Examples 4 and 5. In the present disclosure, the battery obtained through preparation in Example 2 is further tested for 700 cycles. A result shows that the battery obtained through preparation in Example 2 still has a capacity retention rate of 92.3% after 700 cycles. Therefore, it is shown that the positive electrode material coated by the organic coating layer in the present disclosure reduces direct contact between the active material and the electrolyte solution without affecting Li⁺ diffusion, thereby reducing occurrence of a side reaction and effectively alleviating destruction, collapse, or aggregation caused by corrosion of the positive electrode material, improving constitutional stability of the positive electrode material and cycling stability of the battery, effectively suppressing an electrode expansion problem of a silicon-based negative electrode in a cycling process, and thereby further improving safety performance of the battery.

TABLE 1
List of performance test data of a battery

| | Internal | Ratio of a specific | Capacity | Battery |
|---|---|---|---|---|
| | resistance | capacity to a | retention | expansion |
| | of the | theoretical specific | rate after | rate after |
| Item | battery | capacity (25° C.) | 500 cycles | 500 cycles |
| Example 1 | 42 mΩ | 99.1% | 93.4% | 5.2% |
| Comparative | 71 mΩ | 92.3% | 89.2% | 7.8% |
| Example 1 | | | | |
| Example 2 | 55 mΩ | 98.6% | 94.6% | 4.3% |
| Comparative | 76 mΩ | 93.1% | 90.1% | 5.5% |
| Example 2 | | | | |
| Example 3 | 48 mΩ | 95.6% | 89.8% | 6.0% |
| Comparative | 98 mΩ | 88.2% | 62.1% | 6.9% |
| Example 3 | | | | |
| Example 4 | 36 mΩ | 97.6% | 91.6% | 5.1% |
| Comparative | 66 mΩ | 90.1% | 85.4% | 10.4% |
| Example 4 | | | | |
| Example 5 | 43 mΩ | 97.4% | 88.8% | 7.6% |
| Comparative | 97 mΩ | 92.1% | 81.4% | 28.4% |
| Example 5 | | | | |

The implementations of the present disclosure are described above. However, the present disclosure is not limited to the foregoing implementations. Any modifications, equivalent replacements, improvements, and the like within the spirit and principle of the present disclosure shall fall within the protection scope of the present disclosure.

What is claimed is:

1. An electrode active material, wherein the electrode active material comprises an active material and an organic coating layer coated on a surface of the active material; and the organic coating layer comprises a lithiated polymer, and the polymer is a copolymer of a diisocyanate and an alcohol compound.

2. The electrode active material according to claim 1, wherein the lithiated polymer is a polymer obtained by further performing lithiation on the polymer of the diisocyanate and the alcohol compound.

3. The electrode active material according to claim 1, wherein a structural formula of the diisocyanate is shown in formula 1: 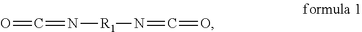
wherein R₁ is a C6-C18 hydrocarbyl.

4. The electrode active material according to claim 1, wherein the diisocyanate is selected from at least one of toluene diisocyanate, isophorone diisocyanate, methylene diphenyl diisocyanate, 4,4′-methylenebis(cyclohexyl isocyanate), hexamethylene diisocyanate, lysine diisocyanate, or diphenylmethane diisocyanate; and/or
the alcohol compound is selected from at least one of diols.

5. The electrode active material according to claim 2, wherein during the lithiation, a lithium reagent is used, and the lithium reagent is selected from at least one of lithium hydride, butyl lithium, ethyl lithium, phenyl lithium, or methyl lithium.

6. The electrode active material according to claim 1, wherein the alcohol compound is pentaethylene glycol.

7. The electrode active material according to claim 5, wherein in the lithiated polymer, a molar ratio of the diisocyanate, the alcohol compound based on —OH, and the lithium reagent based on Li⁺ is 1:(1.5-2.5):(1.5-2.5).

8. The electrode active material according to claim 7, wherein in the lithiated polymer, a molar ratio of the diisocyanate, the alcohol compound based on —OH, and the lithium reagent based on Li⁺ is 1:(2.01-2.05):(2.01-2.05).

9. The electrode active material according to claim 1, wherein the lithiated polymer has a structure shown in formula 2: 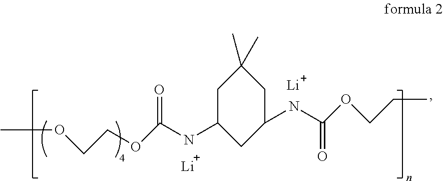
wherein n is a degree of polymerization, and n ranges from 2 to 1.9×10⁶.

10. The electrode active material according to claim 1, wherein the organic coating layer further comprises an ion conductor.

11. The electrode active material according to claim 10, wherein using a total weight of the organic coating layer as a reference, a content of the ion conductor ranges from 3 wt % to 8 wt %.

12. The electrode active material according to claim 10, wherein the ion conductor comprises at least a lithium salt.

13. The electrode active material according to claim 10, wherein the ion conductor is selected from a combination of a lithium salt and at least one of the following materials: an inorganic filler, a magnesium salt, or a sodium salt.

14. The electrode active material according to claim 12, wherein the lithium salt is selected from at least one of lithium bis(oxalate)borate, lithium difluoro(oxalato)borate, lithium hexafluoroarsenate, lithium tetrafluoroborate, lithium trifluoromethanesulfonate, lithium nitrate, lithium bis(fluorosulfonyl)imide, lithium perchlorate, lithium hexafluorophosphate, lithium bis(trifluoromethanesulphonyl)imide, or lithium difluorophosphate.

15. The electrode active material according to claim 13, wherein the inorganic filler is selected from at least one of Li₇La₃Zr₂O₁₂, Al₂O₃, TiO₂, Li_{6.28}La₃Zr₂Al_{0.24}O₁₂, Li_{6.75}La₃Nb_{0.25}Zr_{1.75}O₁₂, Li_{6.75}La₃Zr_{1.75}Ta_{0.25}O₁₂, BaTiO₃, ZrO₂, SiO₂, Li_{1.5}Al_{0.5}Ge_{1.5}(PO₄)₃, or montmorillonite; and/or
the magnesium salt is selected from at least one of magnesium bis(trifluoromethanesulfonimide) (Mg(TFSI)₂) or MgClO₄; and/or
the sodium salt is selected from at least one of sodium difluoro(oxalato)borate (NaDFOB), sodium bis(trifluoromethanesulphonyl)imide (NaTFSI), or NaPF₆.

16. The electrode active material according to claim 1, wherein a thickness of the organic coating layer ranges from 1 nm to 100 nm.

17. The electrode active material according to claim 1, wherein the active material is a positive electrode active material or a negative electrode active material; and/or
a mass ratio of the positive electrode active material or the negative electrode active material to the organic coating layer is 100:(0.1-5).

18. The electrode active material according to claim 17, wherein the positive electrode active material is selected from at least one of lithium ferrous phosphate, lithium cobalt oxide, lithium nickel cobalt manganese, lithium manganate, lithium nickel cobalt aluminate, lithium nickel cobalt manganese aluminate, nickel cobalt aluminum tungsten material, lithium-rich manganese-based solid solution positive material, lithium nickel cobalt oxide, lithium nickel titanium magnesium oxide, lithium nickel oxide, spinel lithium manganese oxide, or nickel-cobalt-tungsten material; and/or
the negative electrode active material is selected from at least one of a carbon material, metal bismuth, metal lithium, metal copper, metal indium, a nitride, a lithium-based alloy, a magnesium-based alloy, an indium-based alloy, a boron-based material, a silicon-based material, a tin-based material, an antimony-based alloy, a gallium-based alloy, a germanium-based alloy, an aluminum-based alloy, a lead-based alloy, a zinc-based alloy, an oxide of titanium, an oxide of iron, an oxide of chromium, an oxide of molybdenum, or a phosphide.

19. An electrode, wherein the electrode comprises the electrode active material according to claim 1.

20. A battery, wherein the battery comprises the electrode active material according to claim 1.
